(19) United States
(12) Patent Application Publication
(10) Pub. No.: US 2010/0068371 A1
(43) Pub. Date: Mar. 18, 2010

(54) Stable, tasty, and attractive gourmet culinary item based upon air-dried and genuine caviar and method of making

(76) Inventor: Serena J. Dean, New York, NY (US)

Correspondence Address: CHARLES E. BAXLEY, ESQUIRE, 90 JOHN STREET, SUITE 309, NEW YORK, NY, 10038, US

(21) Appl. No.: 12/283,772

(22) Filed: Sep. 16, 2008

(51) Int. Cl. A23L 1/328; A23G 3/36

(52) U.S. Cl. 426/615; 426/643

(57) ABSTRACT

A stable, tasty, and attractive gourmet culinary item and method of making. The item includes a foodstuff and caviar. The caviar is air-dried for preventing a need for refrigeration that could damage the foodstuff, is genuine, and is combined with/disbursed in the foodstuff.

### 1. CROSS REFERENCE TO RELATED APPLICATIONS

The instant non-provisional patent application contains subject matter disclosed in Serena J. Dean's provisional patent application No. 60/964,759, filed on Aug. 15, 2007, for CAVIAR IN CHOCOLATE, and incorporated herein by reference thereto.

### 2. BACKGROUND OF THE INVENTION

A. Field of the Invention

The embodiments of the present invention relate to a culinary item, and more particularly, the embodiments of the present invention relate to a stable, tasty, and attractive gourmet culinary item based upon air-dried and genuine caviar and method of making.

B. Description of the Prior Art

The word caviar originates from the Turkish “khavyar,” first appearing in English print in 1591. Dating back 250 million years to prehistoric times, the sturgeon has been a part of the Middle Eastern and Eastern Europe diet for the majority of man's history.

Caviar, a delicacy made from the roe of sturgeons, has been popular as an appetizer and food staple for many centuries. Its consumption has been limited to the nobility and the wealthy because of its very high cost.

Caviar was once reserved strictly for royalty. Yet surprisingly enough, in America during the early nineteenth century, caviar was routinely served during free lunches in saloons. The salty flavor encouraged thirst and enhanced beer sales.

Some chocolate companies produce small beads of chocolate, which they advertise as being special like CHOCOLATE CAVIAR. Yet these companies produce only chocolate, there is no caviar in their products.

Numerous innovations for roe-related compositions have been provided in the prior art, which will be described below in chronological order to show advancement in the art, and which are incorporated herein by reference thereto. Even though these innovations may be suitable for the specific individual purposes to which they address, however, they differ from the present invention in that they do not teach a stable, tasty, and attractive gourmet culinary item based upon air-dried and genuine caviar and method of making.

(1) U.S. Pat. No. 5,397,590 to Scott.

U.S. Pat. No. 5,397,590 issued to Scott on Mar. 14, 1995 in U.S. class 426 and subclass 589 teaches a method for producing caviar-like compositions by mixing and blending dried papaya seeds with an edible oil, a fish flavoring, a thickener, and seasoning.

(2) U.S. Pat. No. 5,510,133 to Yamamoto.

U.S. Pat. No. 5,510,133 issued to Yamamoto on Apr. 23, 1996 in U.S. class 426 and subclass 272 teaches a process for producing a variety of reformed and cured herring roe mixed foods including “herring roe on kelp,” “herring roe on shellfish,” and “herring roe with kamaboko” by making the best use of the intrinsic binding ability of fresh herring eggs. In one embodiment, the process may begin by extracting ovaries from sexually-matured herring. Individual eggs are then singled out from the ovaries. The eggs are rinsed and cleaned. A perforate mold is then filled in single or multi-layers with any solid food or foods, e.g., kelp, fish, shell-fish, kamaboko, ham, sausage, and/or cheese between the layers of eggs, to form a sandwich structure. The sandwich structure in the mold is then salt-cured, substantially to the saturation level. The salt-cured and solidified product is then removed from the mold.

### (3) Japanese Application Publication Number 10-262567 to Takeshi.

Japanese Application Publication Number 10-262567 published to Takeshi on Oct. 6, 1998 in Int. cl A23G and subclass 9/02 teaches a sherbet-like ice cake product obtained by immersing 300 kg pieces of a herring roe for 10-30 minutes into an aqueous solution by adding a 1.7-2.5 liter substance containing 12% sodium hypochlorite to 1000 liters of tap water for a chlorine sterilization, then immersing the roe into an aqueous solution obtained by adding a chorine removing agent, i.e., a neutralizer, a 1000 liter of tap water in a 3% ratio for 1-2 hours, then immersing the roe into an enzyme solution obtained by adding a 1.0% catalase enzyme into 1500 liters of tap water at 35-45° C. for 10-15 minutes to remove the chorion of the herring roe, then washing with water, breaking the obtained herring roe for forming grains of approximately 10 mm sizes, seasoning the roe by dipping with a soy sauce or a slat, then mixing the seasoned roe into an aqueous sherbet solution as a substitute for a caviar, and then freezing while agitating.

(4) U.S. Pat. No. 6,770,311 B2 to Alamian et al.

U.S. Pat. No. 6,770,311 B2 issued to Alamian et al. on Aug. 3, 2004 in U.S. class 426 and subclass 98 teaches a man-made caviar alternative, including granules having a gelled center in a syrup exhibiting the same organoleptic properties as caviar from sturgeon. The granules are made from a mixture of encapsulation material, salt, coloring agents, and flavoring agents, and granules are formed having a size of between about 2 to 4 millimeters. The thus formed granules may be treated with firming agents, crisping agents, and antioxidants. The caviar syrup in which the granules reside is a mixture including flavoring agents, salt, and stabilizing agents.

### (5) Russian PCT Application Number WO 2006/073332 A1 to Hisashi.

Russian PCT Application Number WO 2006/073332 A1 published to Hisashi on Jul. 13, 2006 in Int. cl A23 L and subclass 1/325 teaches producing ready-to-consume long-term-storageable foods. The food product contains a based nutritive component obtainable from a vegetable raw material, for example, flour and/or vegetables, a vegetable oil, a taste-aroma additive consisting of a table salt, starch, fish, and/or prawn powder, and/or dry food yeast exhibiting a characteristic fish odor, sodium glutamate, alpha-tocopherol, fusel pol, milk, oil, or isovaleric acid, and a flavoring matter. The product has a delectable flavor and aroma of red or black caviar with butter.

It is apparent that numerous innovations for roe-related compositions have been provided in the prior art that are adapted to be used. Furthermore, even though these innovations may be suitable for the specific individual purposes to which they address, however, they would not be suitable for the purposes of the embodiments of the present invention as heretofore described, namely, a stable, tasty, and attractive gourmet culinary item based upon air-dried and genuine caviar and method of making.

### 3. SUMMARY OF THE INVENTION

Thus, an object of the embodiments of the present invention is to provide a stable, tasty, and attractive gourmet culinary item based upon air-dried and genuine caviar and method of making, which avoids the disadvantages of the prior art.

Briefly stated, another object of the embodiments of the present invention is to provide a stable, tasty, and attractive gourmet culinary item and method of making. The item includes a foodstuff and caviar. The caviar is air-dried for preventing a need for refrigeration that could damage the foodstuff, is genuine, and is combined with/disbursed in the foodstuff.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood.

### 4. DETAILED DESCRIPTION OF THE PREFERRED EMBODIMENTS

### A. General.

The stable, tasty, attractive gourmet culinary item includes a foodstuff and caviar. The caviar is air-dried for preventing a need for refrigeration that could damage the foodstuff, is genuine, and is combined with/disbursed in the foodstuff.

### B. The Foodstuff.

The foodstuff includes, for example:
A confection;
A chocolate—white, milk, and/or dark;
A truffle;
A bon-bon;
A filled-center candy;
A mousse;
A chocolate candy;
A nutty rocher candy;
A molten fondant—a fondue chocolate that can be melted and used in recipes;
Any other confection utilizing either a powered cocoas or an emulsified chocolate, e.g., cakes and cookies;
A prepared food item;
A bread;
A cracker;
A vegetable;
A meat; and
A fish.

### C. The Additives.

The stable, tasty, and attractive gourmet culinary item may further include additives, which are combined with/disbursed in the foodstuff, and which include, for example:
A fruit puree or a fruit powder;
A ground nut;
A liquid flavor extract of a fruit, a nut, and/or a spice;
An edible gold and/or a similar attractive ingredient;
A liqueur;
A fragrance—a lemon smell, a liqueur smell, and/or a caviar smell;
A rose water; and
A popular essential oil.

### D. The Method of Making the Culinary Item.

STEP 1: Air dry the caviar so as to allow the culinary item to be maintained without refrigeration, thereby preventing the foodstuff from turning white when refrigerated, and to maintain their essence and not souring.
STEP 2: The caviar can be left in its original egg form or can be ground into a course or fine powder for addition to the foodstuff so as to create a superb threat that is a joy to the palate, wherein pulverizing the caviar can be controlled to yield discrete particles in a tight range or sizes, or vary the grain sizes so as to allow concentration of the caviar to be controlled.
STEP 3: Mix the caviar with a liquified foodstuff to disperse the caviar evenly throughout the foodstuff to form a mixture, wherein a slow speed of mixing enables blending of the caviar with the foodstuff without breaking down the structure of the caviar.
STEP 4: Optionally, molding the mixture into bars or package in containers.
STEP 5: Ascertain that the exterior surface of the culinary item consists primarily of the foodstuff by applying powdered foodstuff thereover.

### E. The Impressions.

It will be understood that each of the elements described above or two or more together may also find a useful application in other types of compositions differing from the types described above.

While the embodiments of the present invention have been illustrated and described as embodied in a stable, tasty, and attractive gourmet culinary item based upon air-dried and genuine caviar and method of making, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A stable, tasty, and attractive gourmet culinary item, comprising:
a) a foodstuff; and
b) caviar;
wherein said caviar is air-dried for preventing a need for refrigeration that could damage said foodstuff;
wherein said caviar is genuine; and
wherein said caviar is combined with/disbursed in said foodstuff so as to form said stable, tasty, and attractive gourmet culinary item.

2. The item of claim 1, wherein said foodstuff includes a confection.

3. The item of claim 1, wherein said foodstuff includes chocolate; and
wherein said chocolate of said foodstuff is selected from the group consisting of white, milk, and dark.

4. The item of claim 1, wherein said foodstuff includes a truffle.

5. The item of claim 1, wherein said foodstuff includes a bon-bon.

6. The item of claim 1, wherein said foodstuff includes a filled-center candy.

7. The item of claim 1, wherein said foodstuff includes a mousse.

8. The item of claim 1, wherein said foodstuff includes a chocolate candy.

9. The item of claim 1, wherein said foodstuff includes a nutty rocher candy.

10. The item of claim 1, wherein said foodstuff includes a molten fondant.

11. The item of claim 2, wherein said confection is selected from the group consisting of a powered cocoa and an emulsified chocolate.

12. The item of claim 1, wherein said foodstuff includes a cake.

13. The item of claim 1, wherein said foodstuff includes a cookie.

14. The item of claim 1, wherein said foodstuff includes a prepared food item.

15. The item of claim 1, wherein said foodstuff includes a bread.

16. The item of claim 1, wherein said foodstuff includes a cracker.

17. The item of claim 1, wherein said foodstuff includes a vegetable.

18. The item of claim 1, wherein said foodstuff includes a meat.

19. The item of claim 1, wherein said foodstuff includes a fish.

20. The item of claim 1, further comprising an additive;
wherein said additive is combined with/disbursed in said foodstuff; and
wherein said additive includes a fruit puree.

21. The item of claim 20, wherein said additive includes a fruit powder.

22. The item of claim 20, wherein said additive includes a ground nut.

23. The item of claim 20, wherein said additive includes a liquid flavor extract selected from the group consisting of a fruit, a nut, and a spice.

24. The item of claim 20, wherein said additive includes an edible gold.

25. The item of claim 20, wherein said additive includes a liqueur.

26. The item of claim 20, wherein said additive includes a fragrance; and
wherein said fragrance is selected from the group consisting of a lemon smell, a liqueur smell, and a caviar smell.

27. The item of claim 20, wherein said additive includes a rose water.

28. The item of claim 20, wherein said additive includes an essential oil.

29. A method of making a stable, tasty, and attractive gourmet culinary item, wherein the culinary item includes a foodstuff and caviar, said method comprising the steps of:
a) air drying the caviar so as to allow the culinary item to be maintained without refrigeration, thereby preventing the foodstuff from damage when refrigerated, and to maintain essence and no souring;
b) one of leaving the caviar in its original egg form, and, grounding into a course or fine powder for addition to the foodstuff; and
c) mixing the caviar with liquified foodstuff to disperse the caviar evenly throughout the foodstuff to form a mixture.

30. The method of claim 29, wherein said grounding step includes pulverizing the caviar to control yield of discrete particles in a tight range or sizes, or vary grain sizes so as to allow concentration of the caviar to be controlled.

31. The method of claim 29, wherein said mixing step includes slow speed mixing to enable blending of the caviar with the foodstuff without breaking down structure of the caviar.

32. The method of claim 29, further comprising the step of molding the mixture into bars or packaged in containers.

33. The method of claim 29, further comprising the step of ascertaining that an exterior surface of the culinary item consists primarily of the foodstuff by applying powdered foodstuff thereover.
